(19) United States
(12) Patent Application Publication
(10) Pub. No.: US 2010/0042322 A1
(43) Pub. Date: Feb. 18, 2010

(54) MODULAR NAVIGATION SYSTEM AND METHODS

(76) Inventor: Chang-Hee Won, Maple Glen, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/448,175

(22) PCT Filed: Dec. 11, 2007
(86) PCT No.: PCT/US07/25313

§ 371 Date: Jun. 10, 2009

Related U.S. Application Data
(60) Provisional application No. 60/874,614, filed on Dec. 13, 2006.

(51) Int. Cl. G01C 21/00; G01C 22/00; G01C 21/18

(52) U.S. Cl. 701/213; 235/105; 701/220

(57) ABSTRACT

Systems and methods are provided to generate positioning and orientation data for subjects disposed in stressed environments. In an illustrative implementation, a navigation module comprises an integration module and various sensors to determine the position and orientation of the user. In the illustrative implementation, the navigation module may cooperate with a larger navigation platform comprising a global navigation satellite system (GNSS) receiver, inertial measurement unit (IMU), altimeter, magnetometer, pedometer, and an angular measuring device. Additionally, the illustrative integration module may comprise power and signal conditioning circuitry, a transceiver to send the position and orientation information to other cooperating components such as a monitoring device and integration software for use in processing the various sensor data.

### CROSS-REFERENCE TO RELATED PATENT APPLICATIONS

This patent application claims the benefit of U.S. Provisional Patent Application No. 60/874,614, filed Dec. 13, 2006.

### REFERENCE TO GOVERNMENT GRANT

This invention was made in part with Government support under Grant Number ECS-0554748 awarded by the National Science Foundation. The Government may have certain rights in this invention.

### FIELD OF THE INVENTION

This invention pertains to navigation systems and methods.

### BACKGROUND OF THE INVENTION

Positioning technologies have availed various commercial applications which are becoming commonplace. Included in such technologies are global navigation satellite system (GNSS) applications which have become integrated in various modalities ranging from mobile phones and camping gear to mobile navigation systems. GNSS is a system of satellites that sends navigation signals to a receiver. Although there may be more in the future, currently there are three GNSS systems: Global Navigation Positioning System (GPS), Global Orbiting Navigation Satellite System (GLONASS), and Galileo. GNSS allows users, with some degree of accuracy and reliability, to obtain positioning information from a network of navigation satellites. Such positioning data can then be processed by the various navigation and positioning apparatus to provide users with information regarding their relative position.

Pedometers are used widely, especially by the fitness enthusiasts. Pedometers determine the step size, and determine the distance traveled by multiplying the total number of steps taken by the average stride length. Various different implementations, such as piezo-electric accelerometers, a coiled spring mechanism, a hairspring mechanism, can be used to measure steps. Some current pedometers can also calculate the distance traveled using other components such as an accelerometer. Currently there are GNSS pedometers in the market. These devices generate pedometer-like data using GPS or other global navigation satellite signals.

However, current approaches have various shortcomings when providing positioning and orientation data in stressed environments. A “stressed environment” is an environment where GNSS satellite signals are weak or non-existent. One example of a stressed environment is indoors. Other examples of a stressed environment include, but are not limited to, urban environments,jungles, forests, tunnels and caves. A disadvantage of the satellite based navigation is that the signal can be weak so it is susceptible to interference and jamming. Also, in some instances, it is difficult for satellite navigation signals to reach positioning and navigation receivers when there are tall buildings, dense foliage, tunnels, or caves or when the receivers are indoors. Additionally, current solutions do not utilize various types of complementary data from other sensors to provide optimal estimated positioning and orientation information for subjects in stressed environments etc.

From the foregoing, it is appreciated, that there exists a need for a system and method to overcome the shortcomings of existing approaches and practices.

### BRIEF SUMMARY OF THE INVENTION

Systems and methods are provided to generate navigation, positioning and orientation data for use in stressed environments. For the purpose of this invention, the phrase “stressed environment” will have the meaning given to it in the background section. In an illustrative implementation, the herein described systems and methods relate to a modular, portable, and robust navigation system. In one embodiment, a navigation module comprises an integration module and various sensors to determine the position and orientation of a subject, preferably a human, in a stressed environment. In another embodiment, the navigation module may comprise the integration module and a larger navigation platform comprising a global navigation satellite system (GNSS) receiver, inertial measurement unit (MU), altimeter, pedometer and gyroscope. In other embodiments, the navigation module may comprise an integration module and other combinations of sensors.

The integration module may comprise an integration member and interfaces to obtain data from the sensors. In another embodiment, the integration module may comprise an integration member, interfaces, and power and signal conditioning circuitry. The integration module may also include a communication device, such as a transceiver, to send the position and orientation information to other cooperating components such as a monitoring device. The communication device may be a RF transceiver but is not limited to an RF transceiver. The monitoring device may be, but is not limited to, a personal computer, a laptop computer, or other type of processing device. The integration module may also include a memory device storing integration software for use in processing the data from the sensors in order to generate orientation and position data. Other features of the herein described systems and methods are described below.

### BRIEF DESCRIPTION OF THE DRAWINGS

The system and methods are further described with reference to the accompanying drawings in which:

FIG. 1 is a block diagram of one embodiment of a navigation system in accordance with an implementation of the herein described systems and methods;

FIG. 2 is a block diagram of one embodiment of the navigation module in accordance with one embodiment of the herein described systems and methods;

FIG. 3 is a block diagram showing another embodiment of the herein described systems and method;

FIG. 4 is one embodiment of the calculation of vertical acceleration for a subject;

FIG. 5 is an embodiment of a method of using an angular measuring device to calculate the stride length of a subject;

FIG. 6 is one embodiment of a method of using an angular measuring device to calculate the stride length of a subject;

FIG. 7 is an illustration of the angular rate data from a gyroscope in one embodiment of the method of calculating the stride length of a subject;

FIG. 8 is a comparison between one embodiment using the ZADU method and using direct integration;

FIG. 9 is a flow diagram of an embodiment of the ZADU method; and

FIG. 10 is flow diagram of the processing performed in an illustrative operation in accordance with the herein described systems and methods.

### DETAILED DESCRIPTION OF THE INVENTION

The herein described system and methods illustratively operate to generate robust and reliable output data comprising positioning and orientation data in a stressed environment. In one embodiment, the generation of such data can be accomplished in the absence of reliable satellite-based navigation and positioning signals.

In an embodiment of the invention, a navigation module comprises an integration module and a plurality of sensors. The integration module may comprise an integration member, a memory device storing instructions for determining optimally estimated position and orientation data for a subject in a stressed environment, and a computing device. The integration member may be, but is not limited to, a board or a printed circuit board (PCB). The computing device may be a microprocessor, a processor or a computer. The integration member is connected to each of the sensors. The connection between the integration member and each of the sensors may be wireless, or through wires, a PCB, or other types of connections known in the art. The sensors may be disposed on the integration member or external to the integration member. Additionally, the integration module may also include a power conditioning unit, signal conditioning circuitry and an integration module communications device. The integration module communications device may be, but is not limited to, a transceiver which transmits position and orientation information to a cooperating computer or other monitoring device. In some embodiments, the integration communication device may be a transceiver or an antenna. In other embodiments the communication device may be an RF transceiver. The integration member may include interfaces such as input ports and output ports. Data from a sensor may be received through an input port or by the computing device or signal processing circuitry. Data received from the sensors may be sensor signals. Data or signals received from sensors may also be referred to as navigation data or navigation signals for the purposes of this description of the invention. For the purposes of this invention, devices such as a GNSS receiver, an IMU, an altimeter, a pedometer, a gyroscope, a magnetometer, and other like devices will generally be referred to as sensors.

In one embodiment the navigation module may comprise an integration module and sensors such as a magnetometer, gyroscope, accelerometer, and an altimeter. The integration module may comprise a PCB, a processor and memory. The magnetometer, gyroscope and accelerometer can illustratively generate orientation data. An accelerometer can be used to determine a user's step count. An altimeter can be used to generate height information. In this illustrative embodiment, the navigation module may include a GNSS receiver disposed on the PCB. In an alternate implementation, the integration module may include a PCB connected to an external connector for use with an external GNSS receiver.

In another embodiment, the navigation module may comprise: a GNSS receiver; an orientation determination component such as inertial measurement unit (IMU), which can include magnetometers, gyroscopes, and accelerometers; and the integration module. The navigation module may also include an altitude or height determining component such as an altimeter, and a subject's step determining component such as a pedometer and/or a gyroscope—the number of steps and the stride length can be used to calculate the distance traveled by a user, and an angular measuring device such as a gyroscope to determine the distance traveled and the heading.

In using these exemplary components, operatively the herein described systems and methods aim to provide more accurate position and orientation information. Illustratively, this may be accomplished by fusing data from the sensors, in one embodiment, fusing the GNSS receiver, IMU, altimeter, pedometer, and gyroscope data. Additionally, with the herein described invention, position and orientation information may be computable during GNSS signal dropouts. Further, the use of these components as embodied by modular hardware can shorten development time of the system, reduce costs, and, ultimately, time for deployment. In an illustrative operation, exemplary integration module software stored on the memory device can operate to fuse position and orientation information received from the sensors.

In yet another embodiment of the invention, the herein described system and methods may comprise a mobile subsystem and a base subsystem. For the purposes of this invention, the terms “navigation module” and “mobile subsystem” may be used interchangeably.

In one illustrative implementation, an exemplary base subsystem can be operable to receive data from one or more mobile subsystems and can process such received data for use in decision making (e.g., notifying monitoring personnel with actionable information). In the illustrative implementation, the base subsystem comprises a base station processor, a base station memory device storing base station software, and a base station communication device. The base station communication device may be transceiver. The processor may be, but is not limited to, a laptop or other processing device. Illustratively, the base station software can consist of a portion to handle data reception and a portion for data classification. The data reception can be operable to receive mobile subsystem data and store such data in a cooperating database. Additionally, the data classification software can operate to autonomously process mobile subsystem data, classify activities, and notify the monitoring person if action is needed. The base subsystem may include a display and a mechanism for manipulating received data or data processed by the base subsystem.

By way of example, the herein described systems and methods can allow soldiers in the battle field to know their positions—where they are—and orientations—where they are facing. For instance, if soldiers are in an urban environment (e.g., an environment having tall buildings that block desired satellite navigation signals) then the IMU, pedometer, gyroscope and altimeter can be used to generate position and orientation information. In this example, the herein described systems and methods can be use to transmit a soldier's position and orientation data to a cooperating base subsystem so that the soldier can be monitored. For example, if a friendly tank is planning to attack the enemy bunker in the battlefield, the tank commander could tell where the friendly forces are before launching an attack. This would reduce the friendly fire casualties.

In another example, the herein described system and methods can be used to track and monitor sick patients who might need emergency care. For example, patients with Alzheimer's disease can be monitored to detect when the patient is facing down when s/he shouldn't be facing down. Using such monitored orientation and position information, appropriate steps can be taken to notify attending caretakers.

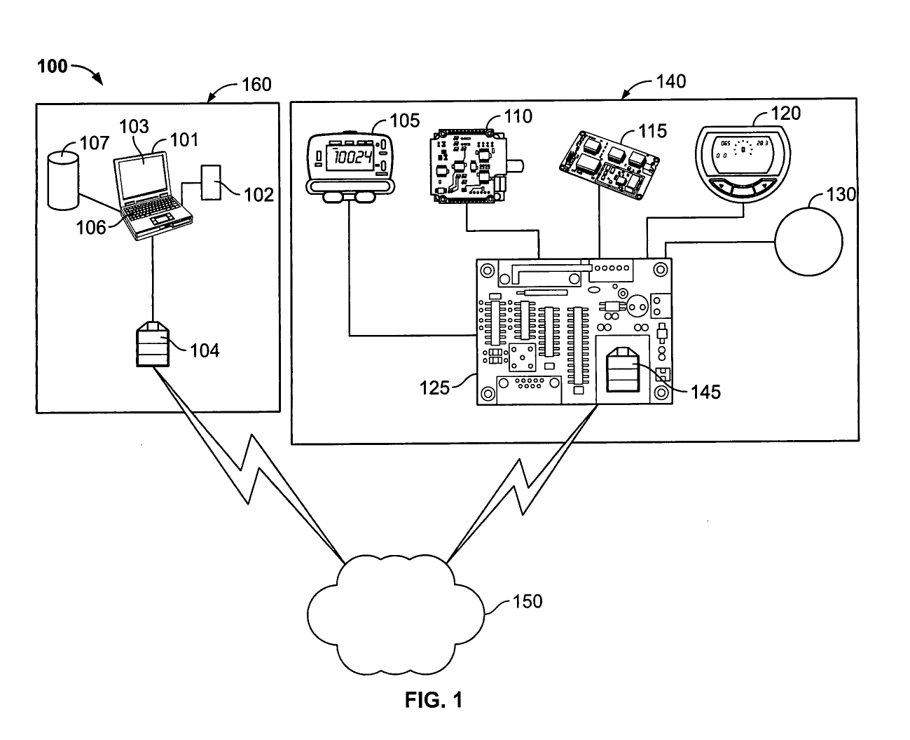

FIG. 1 shows one embodiment of a navigation system 100 having navigation module (mobile subsystem) 140 communicating with base subsystem 160 through a communications network 150. As illustrated in the embodiment shown in FIG. 1, the mobile subsystem 140 may comprise various sensor components such as a pedometer 105, IMU 110, GNSS receiver 115, altimeter 120, an angular measuring device such as agyroscope 130, and integration module 125. In a different embodiment, the mobile subsystem may comprise a GNSS receiver 115, and IMU 110 and a gyroscope 130. In yet another embodiment, the mobile subsystem may comprise a GNSS receiver 115, an IMU 110, a gyroscope 130, and an altimeter 120. In other embodiments, the mobile subsystem may comprise other combinations of sensors. The integration module 125 communicates with the various sensor components and receives from the sensor signals from the various sensor components. In one embodiment the sensor components may be disposed on the integration module 125 and in another embodiment the sensor components may communicate with the integration module 125 through one or more input interfaces. As is shown in FIG. 1, the exemplary base subsystem 160 comprises a base station processor 101, abase station memory device 102 storing base station software, and a base station transceiver 104. In a preferred embodiment, the base subsystem may also have a display 103, a user mechanism 106 for manipulating data and a database 107. The processor 101 communicates with the base station transceiver 104. In one embodiment the processor 101, base station memory storing device 102, display 103 and user mechanism 106 may be part of a laptop computer, whereas in another embodiment they may be part of a PDA or other computing device. Illustratively, the base station software may comprise a portion to handle data reception and a portion for data classification. The data reception may receive mobile subsystem data and store such data in the cooperating database 107. Additionally, the data classification software may autonomously process mobile subsystem data, classify activities, and notify the monitoring person if action is needed.

In an illustrative operation, the data generated by mobile subsystem 140 can be communicated, through the mobile subsystem transceiver 145, to the base subsystem 160 for monitoring, tracking, and reporting. In the embodiment illustrated in FIG. 1, the mobile subsystem transceiver 145 is part of the integration module and may be disposed on the integration member. In another embodiment, a communication device such as a mobile subsystem transceiver may be external to the integration member and connected to an output port (not shown in FIG. 1) of the integration member. In the embodiment shown in FIG. 1, the mobile subsystem transceiver 145 communicates to the base station transceiver 104 over a communications network 150. In a preferred embodiment, both the mobile subsystem transceiver 145 and the base station transceiver 104 are RF transceivers. In the illustrative operation, a participating user operating the functions and operations of mobile subsystem 140 can be monitored by base subsystem 160. Such monitoring data can be used by decision makers (not shown) to assist them in making decisions regarding the participating user (e.g., in a military context—whether to attack based on the position of soldiers).

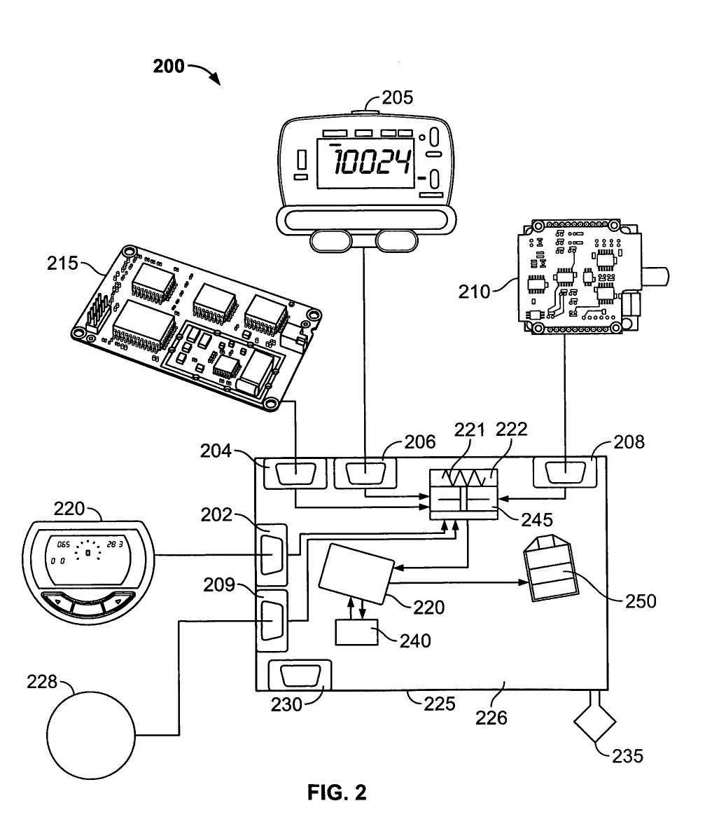

FIG. 2 shows a detailed view of exemplary navigation module 200. As is shown, navigation module 200 comprises integration module 225 which is shown to cooperate with various sensors, such as a pedometer 205, IMU 210, GNSS receiver 215, altimeter 220, and gyroscope 228. The gyroscope 228 in FIG. 2 is an angular measuring device. Further, as is shown in the embodiment in FIG. 2, the various sensors may interface with mobile subsystem 225 through various input ports including input ports 202, 204, 206, 208 and 209 disposed on integration member 226. Additionally, the integration module 225 may include output port 230, antenna 235, processor 220, a power conditioning unit 221, signal conditioning circuitry 222, integration module memory 240, and a transceiver 250.

In an illustrative operation, mobile subsystem 200 can operate according to one or more instructions stored on an integration module memory 240 to obtain navigation, positioning, altitude, step, and orientation information from the various sensor components 215, 220, 205, 210 and 228, through input ports 202, 204, 206,208 and 209, respectively for processing by the processor 220. In a preferred embodiment, the processor is a microprocessor. Additionally, in the illustrative operation, a power conditioning unit 221 and signal conditioning circuitry 222 may operate to modify the signals received as input from the various sensor components so that the signals can be processed by microprocessor 220. The memory 240 may store one or more instructions to process the sensor data when a participating subject (not shown) is disposed in a stressed environment in order to calculate the optimally estimated position and orientation data of the subject. Such data may be processed according to one or more selected data processing paradigms which include, but are not limited to, Kalman filtering, data fusion, extrapolation, interpolation, regression, and interpretation.

In the illustrative operation, such optimally estimated positioning and orientation data may be communicated to the base subsystem 160 (see FIG. 1) through a communication device. The communication device may be, but is not limited to, a transceiver 250 or an antenna 235. In this embodiment the communication device is a transceiver disposed on the integration member 226. In an alternative embodiment, the transceiver may be disposed external to the integration member 226 and connected to the output port 230.

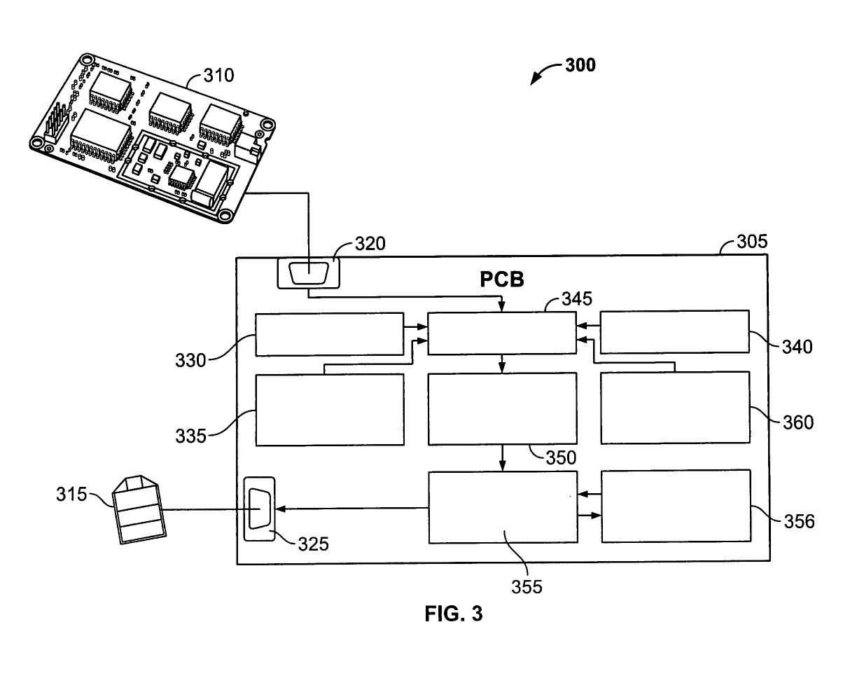

FIG. 3 illustrates another embodiment of an integration module 300. As is shown in FIG. 3 exemplary integration module 300 comprises integration member 305, a GNSS receiver 310, a microprocessor 355, a memory 356 and a transceiver 315. In the embodiment shown in FIG. 3, the integration module 300 also includes various navigation components, including but not limited to, gyroscope 330, accelerometer 360, magnetometer 340, altimeter 335, power conditioning unit 345, and signal conditioning unit 350. Additionally, as is shown in FIG. 3, the exemplary integration module 300 comprises at least one input port 320 for use in communicating data from the GNSS receiver 310 to the processor 355. In the illustrative implementation, output port 325 communicates position and orientation data from the microprocessor 355 to the transceiver 315. The transceiver 315 communicates the data to, and may receive data from, the base subsystem (not shown); received data is communicated to the microprocessor 355.

In an illustrative operation, microprocessor 355 can receive signals representative of input data from one or more of the navigation sensor components (e.g., gyroscope 330, accelerometer 360, magnetometer 340, and altimeter 335) that are conditioned by power conditioning unit 345 and signal conditioning unit 350. Such input data can be processed by microprocessor 355 to generate optimally estimated positioning and orientation data for communication to the cooperating components (not shown) using output 325 and transceiver 315. In an illustrative implementation, the cooperating components (not shown) may comprise exemplary base subsystem 160 of FIG. 1

In the illustrative operation, microprocessor 355 can comprise one or more instructions to process sensor data and to estimate optimal positioning and orientation data when a participating subject (not shown) is in a stressed environment. Such data may be generated according to one or more selected data processing paradigms which include but are not limited to Kalman filtering, data fusion, expert systems, extrapolation, interpolation, regression, and interpretation.

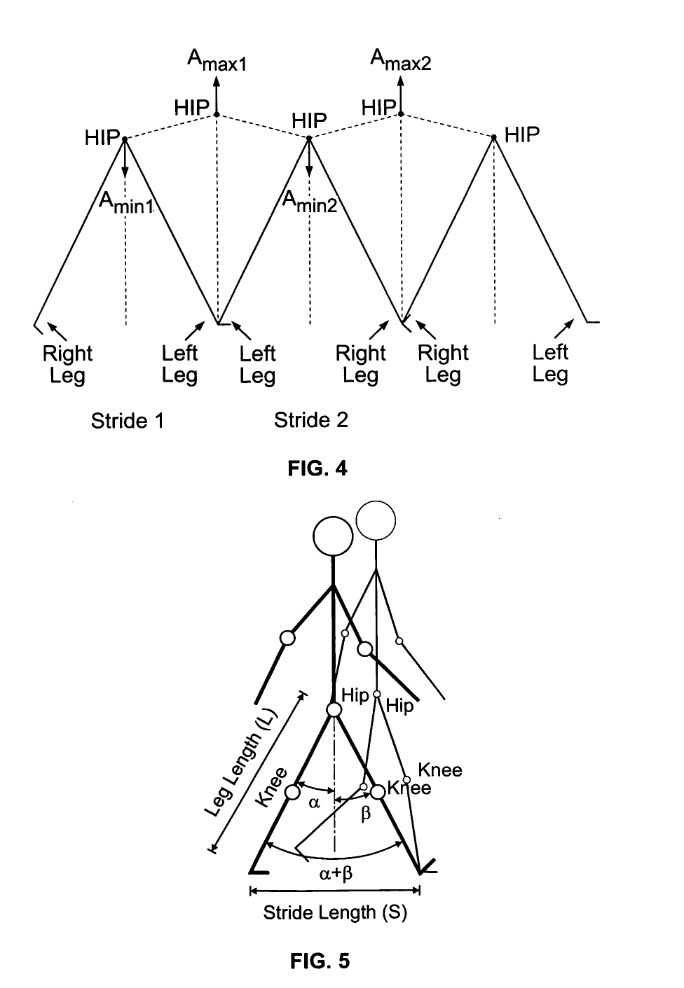

The navigation module calculates the distance traveled by a walking subject. The navigation module may calculate the distance using the step count from a pedometer and multiplying the step count times the average stride length. As an alternative, the navigation module may use the vertical acceleration of the subject's hip as shown in FIG. 4 to calculate the distance traveled. A novel method utilized by the navigation module to calculate the distance traveled by a walking subject utilizes an angular measuring device worn by the subject. In an embodiment, the navigation module includes an angular measuring device disposed substantially on a lower thigh. In a preferred embodiment, the angular measuring device is generally disposed on the side of the knee of the subject's leg. The angular measuring device in the preferred embodiment may be a gyroscope. In another embodiment the angular measuring device may be an IMU or other type of sensor which measures angular rate such as a gyroscope. As a result, the angular rate of leg movement may be measured using those sensors. After the integration of the data received from the angular measuring device, the angular displacement α and β is obtained. Then, by using the geometric formula below, the stride length S may be calculated if the leg length L is known for the subject.

S=L·{square root over (2·(1−cos(α+β)))}

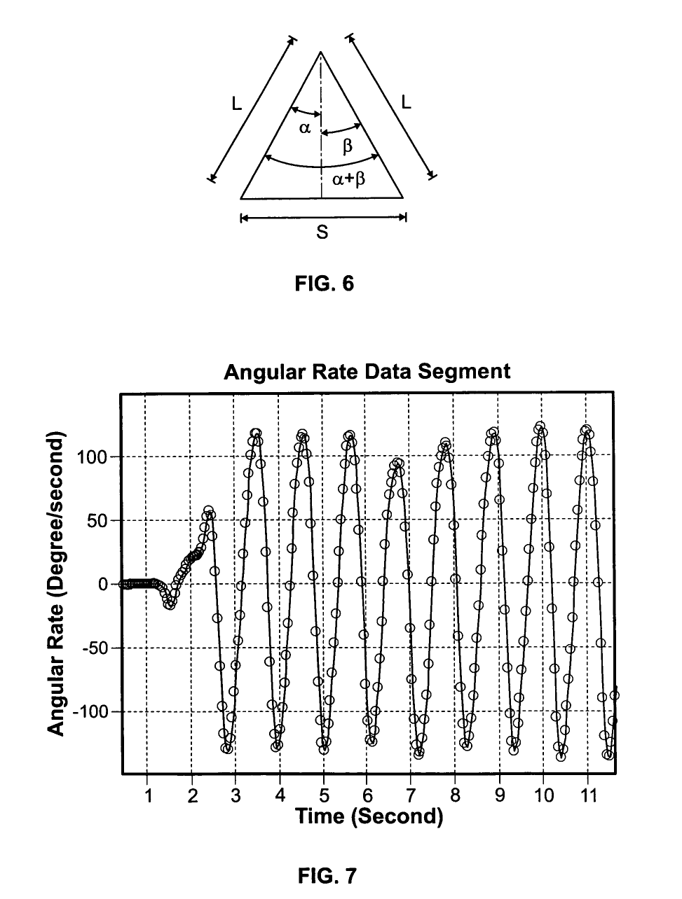

FIGS. 5 and 6 illustrate the movement and α, β, L and S. The angles are obtained from the angular measuring device. FIG. 7 shows the actual angular rate data from a gyroscope. The distance traveled by the subject may be calculated by multiplying the stride length times the steps taken. When integration of the angular rate is performed, error accumulates. Moreover, if simple integration is used to calculate the angular displacement, after a few seconds, the error will be quiet large. To decrease the error Zero Angular Displacement Update (ZADU) is used.

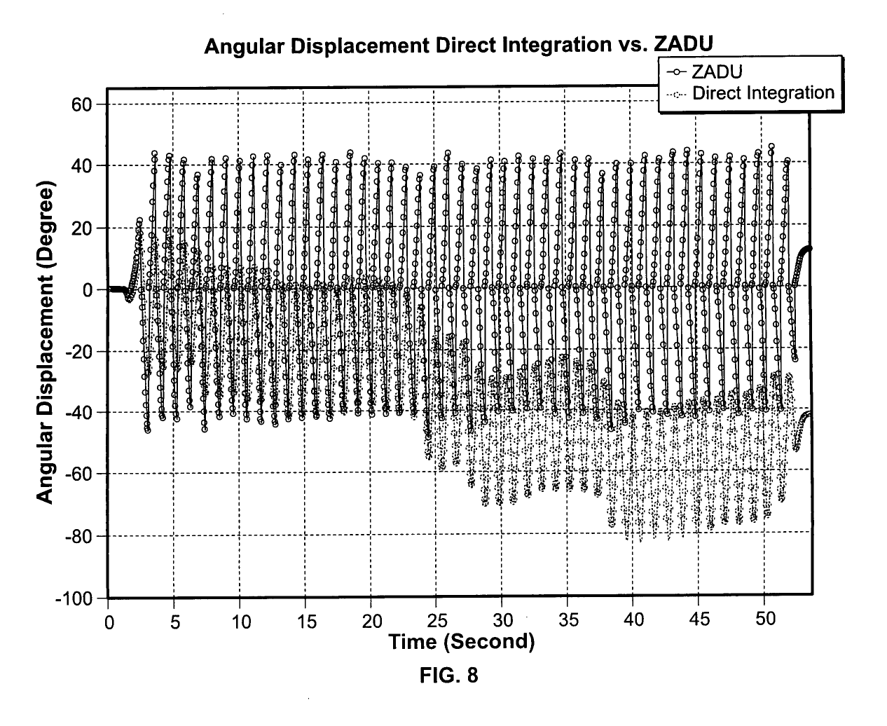

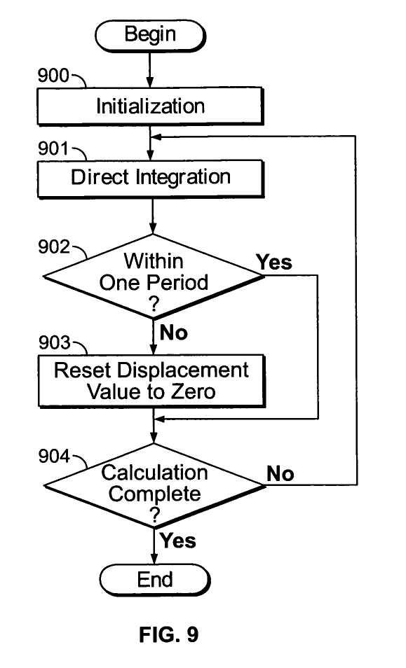

In ZADU, integration is carried out separately in each step. The initial value of each time of integration is always zero, thus the next calculation does not include errors from previous calculation. In FIG. 8, the top graph shows the results from ZADU method, and the bottom graph is without the ZADU method. FIG. 9 shows the flowchart of the ZADU algorithm.

FIG. 9 illustrates exemplary processing performed utilizing the ZADU integration. As is shown, processing for ZADU integration begins in block 900 where initialization is performed. Processing proceeds to block 901 where direct integration is performed. Next, a check is done in block 902 to determine whether the integration is within one period. If the answer is yes, a check is determined in block 904 to verify whether the calculation is complete. If the answer is yes to the check done in block 904, the integration is complete. If the answer is no to the check done in block 904, processing block 901 is returned to and the steps are repeated. If the answer is no to the check done in block 902 then the displacement value is reset to zero in block 903 and the processing proceeds to block 904.

In order to track a subject when a GNSS signal is unavailable, the navigation module must estimate the heading angle as well as the distance traveled. The navigation module may include sensors such as gyroscopes, IMUs, and magnetometers to determine the heading angle. To determine the heading angle based on angular rate data, integration must be performed by the processor of the navigation module. Various methods may be used by the processor to reduce the integration error in determining the heading angle. Integration is generally carried out only when the angular rate is larger than a “threshold,” for example, in one embodiment, the threshold may be set for turns that are more than 10 degrees. In other embodiments the threshold may be different. The navigation module may include other sensors such as vision sensors and magnetometers to aid an angular rate sensor. For example, if a subject is walking inside a building, and the vision sensor determines that the subject is turning a corner, then the turning angle may be reset to ninety degrees instead of the angle given by the angular rate sensor.

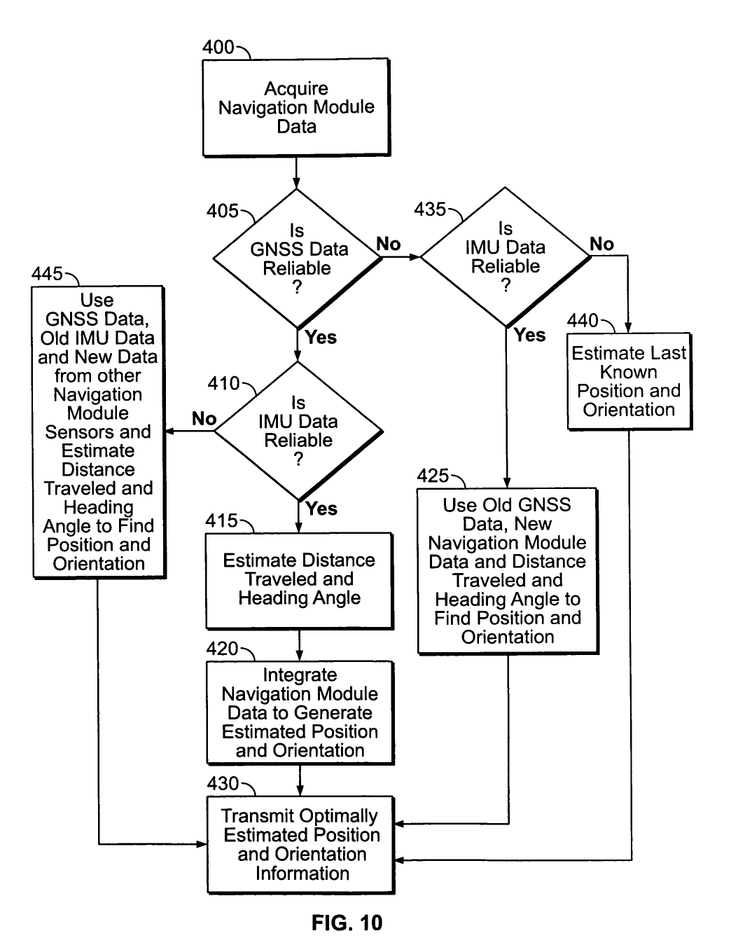

FIG. 10 shows exemplary processing performed when generating positioning and orientation data in a stressed environment. As is shown processing begins at block 400 where navigation module data is acquired. The navigation module data includes the available data from the sensors in communication with the integration module. In the embodiment illustrated in FIG. 2, the navigation module data may include available data from the GNSS receiver, an IMU, an altimeter, a pedometer, and an angular measuring device such as a gyroscope. Navigation data is not limited to the data from this particular combination of sensors. In a different embodiment, navigation data may comprise data from a different combination of sensors than that shown in FIG. 2.

Processing proceeds to block 405 where a check is performed to determine if the GNSS data is reliable. If the check at block 405 indicates that the GNSS data is reliable, a check is performed at block 410 to determine if the IMU data is reliable. If the check at block 410 indicates that the IMU data is reliable, then the distance traveled and heading angle are estimated using the acquired GNSS data at block 415 and data from other sensors in communication with the navigation module such as the gyroscope, the magnetometer, the IMU, the altimeter or the pedometer. From there processing proceeds to block 420 where the navigation module data are integrated to estimate position and orientation. The optimally estimated position and orientation data can then be transmitted to cooperating components at block 430.

However, if the check performed at block 405 indicates that that GNSS data is not reliable, processing proceeds to block 435 where a check is performed to determine if the IMU data is reliable. If the check at block 435 indicates that the IMU data is reliable, processing proceeds to block 425. In block 425, the last good GNSS data is used, and new data from the other sensors in communication with the navigation module is used to calculate the distance traveled and heading angle, which in turn are used to estimate position and orientation. Processing proceeds to block 430 where the calculated optimally estimated position and orientation information is transmitted and continues from there.

However, if the check at block 435 indicates that the IMU data is unreliable, processing proceeds to block 440 where the last known position and orientation information are estimated. Processing then proceeds to block 430 and continues from there. Also, if the check at block 410 indicates that the IMU data is not reliable, the new GNSS data, old IMU data, and the new data from the other sensors communicating with the navigation module (for example, in one embodiment, an altimeter, gyroscope, magnetometer, and pedometer data) are used at block 445 to estimate the distance traveled and heading angle which in turn are used to estimate position and orientation. Processing then proceeds to block 430 and continues from there.

In an illustrative implementation, the processing described in FIG. 10 may be performed by exemplary computing software executing on exemplary mobile subsystem 140 of FIG. 1. In an illustrative operation, the exemplary computing software may check for the reliability of the GNSS and IMU data. For GNSS data, a check can be performed to determine the whether the visible number of satellites, position, time, and heading information are reasonable. For IMU data a check maybe performed to determine the appropriateness of yaw, roll, pitch angles in the north-east-down coordinate system. If both GNSS and IMU data are reliable the position information may be estimated using GNSS (e.g., in this context the estimated position error may be calculated to be less than ten meters in a root mean square (RMS)). Orientation information may be generated by fusing GNSS heading information with the IMU's angular information to generate best roll, yaw, pitch angles. When both GNSS and IMU data are reliable then data from a sensor such as a pedometer, magnetometer or an angular measuring device such as a gyroscope may be used to estimate the distance traveled. However, when the GNSS data and the IMU data are both unreliable, an error message may be generated and the last known position and orientation information maybe provided. If GNSS data is reliable but IMU data is not, new GNSS data, old orientation data from the IMU, and new information from other navigation module sensors (for example, in one embodiment, a gyroscope, magnetometer, altimeter, pedometer etc.) may be used to estimate the distance traveled and the heading angle which in turn are used to estimate position and orientation information. If GNSS is unreliable but IMU data is reliable, the old GNSS data can be used to provide the initial position and the current position and orientation can be estimated using the IMU and data from other sensors (for example, in one embodiment, a gyroscope, magnetometer, pedometer, altimeter, etc.) in communication with the navigation module. In an illustrative implementation, generated data may be transmitted to a base subsystem or other cooperating components and optimally such data communication may be encrypted.

It is understood that the herein described systems and methods are susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the herein described systems and methods may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the herein described system and methods have been described in detail above, those skilled in the art will readily appreciate that many additional modifications are possible in the exemplary embodiments without materially departing from the novel teachings and advantages of the herein described system and methods. Accordingly, these and all such modifications are intended to be included within the scope of this herein described system and methods. The herein described system and methods may be better defined by the following exemplary claims.

What is claimed is:

1. A mobile system comprising:
an integration module comprising a processor, a memory device and a plurality of input ports connected to the processor;
a GNSS receiver connected to a first input port of the plurality of input ports;
an IMU worn by a subject in a stressed environment, the IMU connected to a second input port of the plurality of input ports; and
a step determining sensor worn by the subject, the step determining sensor connected to a third input port of the plurality of input ports, wherein the processor receives sensor signals from at least two of the plurality of input ports and processes the received sensor signals according to a selected data processing paradigm, stored on the memory device, in order to generate output data representative of position data and orientation data for the subject in the stressed environment.

2. The system according to claim 1 further comprising an altimeter worn by the subject, the altimeter connected to a forth input port of the plurality of input ports.

3. The system according to claim 2 further comprising an angular measuring device worn by the subject, the angular measuring device connected to a fifth input port of the plurality of input ports.

4. The system according to claim 3, wherein the angular measuring device is a gyroscope substantially disposed on a side of a knee of the subject.

5. The system according to claim 3 the integration module further comprising an integration board, wherein the processor is substantially attached to the integration board.

6. The system according to claim 5, wherein the integration board is a printed circuit board.

7. The system according to claim 3 wherein the processor is a microprocessor.

8. The system according to claim 3, wherein the memory device stores the output data.

9. The system according to claim 3, the integration module further comprising a power conditioning unit to modify power characteristics of the sensor signals to be processed by the processor.

10. The system according to claim 3 the integration module further comprising a signal conditioning unit to modify the signal characteristics of the sensor signals to be processed by the processor.

11. A system comprising:
a mobile subsystem comprising:
an integration module comprising:
an integration processor;
an integration module memory device; and
a plurality of input ports connected to the integration processor;
a GNSS receiver connected to a first input port of the plurality of input ports;
an IMU worn by a subject in a stressed environment, the IMU connected to a second input port of the plurality of input ports;
a gyroscope worn by the subject and connected to a third input port of the plurality of input ports; and
a integration module transceiver, wherein the integration processor receives sensor signals from at least two of the plurality of input ports and processes the received sensor signals according to a selected data processing paradigm, stored on the integration module memory device, to generate output data representative of position data and orientation data for the subject, wherein further, the integration module transceiver receives the output data from the processor; and
a base subsystem comprising a base station transceiver and a base station processor, wherein the base station transceiver receives the output data from the integration module transceiver and communicates the output data to the base station processor.

12. The system according to claim 11 the integration module further comprising a power conditioning unit to modify power characteristics of the sensor signals to be processed by the integration processor.

13. The system according to claim 11 the integration module further comprising a signal conditioning unit to modify the signal characteristics of the sensor signals to be processed by the integration processor.

14. The system according to claim 11 further comprising a base station database for storing received the output data.

15. The system according to claim 11 wherein the base station processor is a laptop computer.

16. The system according to claim 11 wherein the integration module transceiver and the base station transceiver are RF transceivers.

17. A method comprising:
receiving navigation data from a GNSS receiver, IMU sensor and at least one angular measuring device for a subject disposed in a stressed environment;
determining whether the GNSS data is reliable;
determining whether the IMU data is reliable;
processing the navigation data received from the GNSS receiver, the IMU, and the angular measuring device according to at least one estimation algorithm when data received from one of the GNSS data receiver and the IMU is unreliable; and
generating orientation and position data for the subject disposed in the stressed environment based on the at least one estimation algorithm.

18. The method of claim 17, wherein the angular measuring device is a gyroscope worn by the subject and disposed substantially near a knee of the subject.

19. The method of claim 18 further comprising transmitting to a base subsystem the generated orientation and position data and classifying the generated orientation and position data.

20. The method of claim 18, wherein the receiving navigation data step further comprises receiving navigation data from a pedometer and an altimeter worn by the subject, and the processing navigation data step further comprises processing the navigation data received from the pedometer and the altimeter according to the estimation algorithm.
